(19) United States
(12) Patent Application Publication
(10) Pub. No.: US 2015/0012160 A1
(43) Pub. Date: Jan. 8, 2015

(54) DAMPING CONTROL DEVICE AND DAMPING CONTROL METHOD FOR VEHICLE USING ELECTRIC MOTOR

(71) Applicant: Nissan Motor Co., Ltd., Kanagawa (JP)

(72) Inventors: Junji Tsutsumi, Kanagawa (JP); Akira Sawada, Kanagawa (JP)

(73) Assignee: NISSAN MOTOR CO., LTD., Kanagawa (JP)

(21) Appl. No.: 14/379,067

(22) PCT Filed: Jan. 24, 2013
(86) PCT No.: PCT/JP2013/051495

§ 371 Date: Aug. 15, 2014

(30) Foreign Application Priority Data
Feb. 15, 2012 (JP) 2012-030284

(51) Int. Cl. B60L 11/14; B60L 15/20

(52) U.S. Cl. CPC B60L 11/14; B60L 15/20; B60L 15/2045; B60L 2240/421; B60L 2240/423; B60L 2240/429; B60L 2240/645; B60L 2250/28; B60L 2260/42
USPC 701/22

(57) ABSTRACT

A damping control method of a vehicle using an electric motor for suppressing vibration of the vehicle using the electric motor as a power source includes setting a drive torque target value based on vehicle information of the vehicle, and performing filter processing on the drive torque target value using a damping filter having a characteristic of removing or reducing a frequency component equivalent to torsional vibration of a vehicle drive system based on a vehicle information of the vehicle and an external disturbance suppression filter for suppressing external disturbance, the damping filter calculating a first torque target value and having a characteristic Gm(s)/Gp(s) configured by a model Gp(s) of a transfer characteristic of a torque input to the vehicle and a motor rotation speed and an ideal model Gm(s) of the transfer characteristic of the torque input and the motor rotation speed set in advance.

### CROSS-REFERENCE TO RELATED APPLICATIONS

The present application claims priority to Japanese Patent Application No. 2012-30284, filed on Feb. 15, 2012, the contents of which are hereby incorporated by reference in its entirety.

### BACKGROUND

1. Technical Field

This invention relates to a damping control device and a damping control method of a vehicle using an electric motor.

2. Related Art

A damping control method for suppressing vibration generated in a vehicle is conventionally known in a vehicle using an electric motor such as an electric vehicle or a hybrid vehicle. For example, according to patent literature 1, a first torque target value is calculated by performing a damping filter processing for removing or reducing a natural vibration frequency component of a torque transmission system of a vehicle, on a drive torque target value Tm1 of an electric motor calculated from an accelerator pedal opening, a vehicle speed and the like. A second torque target value Tm2 is then calculated by performing an external disturbance suppression filter processing based on a deviation between an estimated value and an actual value of a motor rotation speed. A drive torque command value is obtained by adding these target values, and a current of the electric motor is so controlled that a torque of the electric motor matches the drive torque command value, thereby suppressing vibration.

The patent literature 1 aims to suppress rotational vibration due to, for example, a resonance between the motor and a wheel drive system from the motor to wheels, by a motor torque control, thereby making it possible to obtain a damping effect also when an accelerator pedal is depressed in a stopped state or a decelerated state.

### CITATION LIST

### Patent Literature

Patent literature 1: JP2003-9566 A

### SUMMARY OF INVENTION

In an electric drive vehicle such as an electric vehicle or a hybrid vehicle, a resonance point of a wheel drive system from an electric motor to wheels also changes as a road surface friction coefficient (road surface μ) changes in wet weather, cold climates and the like.

However, according to the above patent literature 1, there is a difference between a resonance point on an actual road surface and a resonance point in a damping control if the vehicle runs on a low friction coefficient road surface (low μ road) using a control parameter corresponding to a high friction coefficient road surface (high μ road). Thus, in the above patent literature 1, a sufficient damping control effect cannot be obtained when the road surface friction coefficient (road surface μ) changes. There is occurrence of hunting such as when the accelerator pedal is depressed in a stopped state or a decelerated state in a scene where the road surface friction coefficient (road surface μ) changes.

One or more embodiments of the present Invention provides a damping control device of a vehicle using an electric motor that can provide a sufficient damping control effect even when a road surface friction coefficient changes.

One or more embodiments of the present invention includes estimating a road surface friction coefficient and correcting a control parameter in execution of a damping control for reducing torsional vibration of a vehicle drive system based on the estimated road surface friction coefficient.

According to this invention, even when the friction coefficient of the road surface on which the vehicle is running changes, the control parameter in executing the damping control for reducing the torsional vibration of the vehicle drive system can be adjusted according to the friction coefficient of the road surface. Thus, a damping control effect can be sufficiently obtained.

### BRIEF DESCRIPTION OF DRAWINGS

FIG. 1 is a system configuration diagram of an electric drive vehicle according to an embodiment of this invention;

FIG. 2 is a control flow chart describing an operation control process of an electric motor;

FIG. 3 is a characteristic diagram of a map showing a relationship of a motor rotation speed, an accelerator pedal opening and an output torque;

FIG. 4 is a control block diagram describing an estimation process of a road surface friction coefficient μ performed in a step S3 of FIG. 2;

FIG. 5 is a control block diagram showing a damping control procedure according to this embodiment;

FIGS. 6A and 6B are diagrams showing equations of motion of the vehicle;

FIG. 7 is a flow chart describing an estimation process of the road surface friction coefficient μ;

FIG. 8 is a control block diagram when the control block diagram shown in FIG. 5 is equivalently converted;

FIG. 9 is a diagram showing a characteristic curve of a transfer function H(s) used in this embodiment;

FIG. 10 is a flow chart describing a damping control constant changing process;

FIG. 11 is a diagram showing a characteristic of a natural vibration frequency fp corresponding to the road surface friction coefficient μ;

FIG. 12 is a diagram showing a characteristic of a damping coefficient ζ corresponding to the road surface friction coefficient μ;

FIGS. 13A-13C are a timing chart showing a control result by a comparative example; and

FIGS. 14A-14C are a time chart showing a control result according to this embodiment.

### DETAILED DESCRIPTION

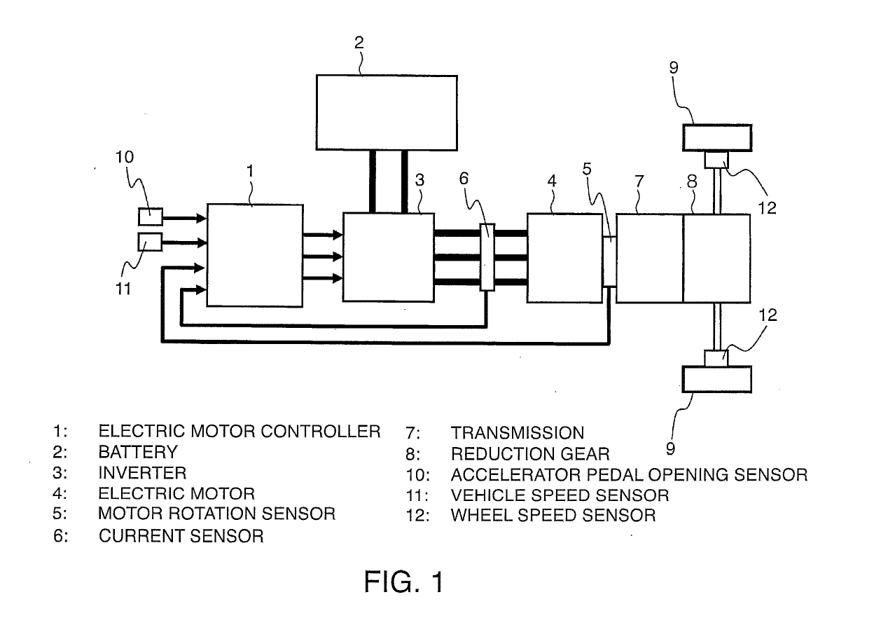

Referring to the drawings, embodiments of the present invention will be described. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention. FIG. 1 is a diagram showing a system configuration of an electric drive vehicle according to the embodiment of this invention. Drive system components of the vehicle comprise a battery 2, an inverter 3, an electric motor 4, a transmission 7, a reduction gear 8, and drive wheels 9. Control system components of the vehicle comprise an electric motor controller 1, a motor rotation sensor 5, a current sensor 6, an accelerator pedal opening sensor 10, a vehicle speed sensor 11 and a wheel speed sensor 12.

The electric drive vehicle to which this embodiment is applied is a vehicle that supplies power from the battery 2 to the electric motor 4 and drives the drive wheels by power charged in the battery 2.

The electric motor controller 1 receives signals of various vehicle variables such as a vehicle speed V detected by the vehicle speed sensor 11, an accelerator pedal opening θ detected by the accelerator pedal opening sensor 10, a rotation speed wm of the electric motor detected by the motor rotation sensor 5 and a current of the electric motor 4 detected by the current sensor 6 (iu, iv, iw in the case of three-phase alternating currents) in the form of digital signals from these respective sensors, generates a PWM signal for controlling the electric motor 4 according to the various vehicle variables, and generates a drive signal of the inverter 3 through a drive circuit according to the generated PWM signal.

The battery 2 is constituted by a secondary battery capable of charging and discharging, and charges regenerative power by the electric motor 4 and discharges drive power to the electric motor 4.

The inverter 3 is connected to each of the battery 2 and the electric motor 4, converts three-phase alternating current power generated by the electric motor 4 into a direct current and supplies it to the battery 2 and inverts direct current power of the battery 2 into three-phase alternating current power and supplies it to the electric motor 4. It should be noted that an inverter including two switching elements (e.g. power semiconductor elements such as IGBTs) for each phase and configured to convert and invert a direct current into an alternating current by ON/OFF controlling the switching elements according to a drive signal can be, for example, used as the inverter 3.

The electric motor 4 generates a drive force by the alternating current supplied by the inverter 3 and transmits the drive force to the left and right drive wheels 9 through the transmission 7 and the reduction gear 8. On the other hand, the electric motor 4 is rotated together with the left and right drive wheels 9 such as during deceleration running of the electric drive vehicle, thereby generating a regenerative drive force to regenerate energy. Further, as shown in FIG. 1, the electric motor 4 is provided with the current sensor 6 for detecting a current of each phase and the motor rotation sensor 5 for detecting the rotation speed wm of the electric motor 4. The motor rotation sensor 5 may be constituted by, for example, a resolver and an encoder.

The transmission 7 is a two-speed transmission having a low gear and a high gear and normally set to obtain a highest performance in both an acceleration and a maximum vehicle speed. In this embodiment, a multi-speed transmission or a continuously variable transmission may be used instead of the two-speed transmission or a configuration including no transmission may also be adopted.

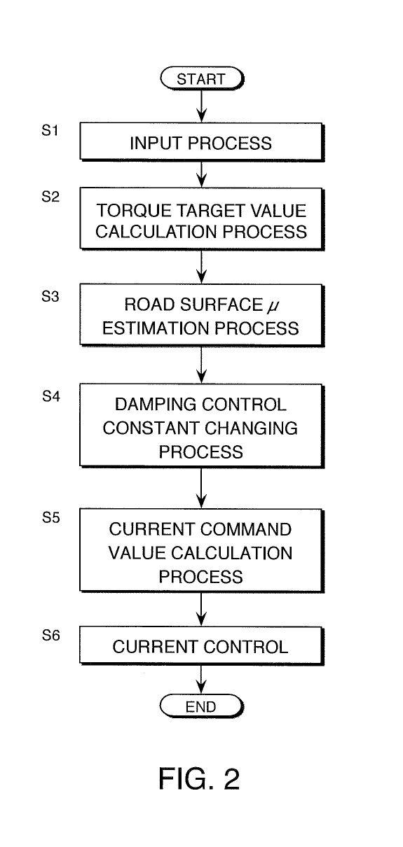

Next, a main operation control of the electric motor controller 1 will be described referring to a flow chart shown in FIG. 2, taking as an example a case where a road surface friction coefficient μ (hereinafter, referred to as a “road surface μ”) is low (e.g. compacted snow road surface or wet road surface). It should be noted that computations described below are performed in every predetermined control computation cycle of, e.g. ten milliseconds in the electric motor controller 1.

In an input process of a step S1, various signals required for various control computations described below are obtained through sensor inputs or communication with another controller. In this embodiment, three phase currents iu, iv and iw flowing in the electric motor 4, the rotation speed ωm of the electric motor 4, the vehicle speed V (driven wheel speed V), the accelerator pedal opening θ and a direct current voltage value Vdc are, for example, obtained in the input process of the step S1.

Specifically, in the step 51, the three-phase currents iu, iv and iw flowing in the electric motor 4 are obtained from the current sensor 6. It should be noted that since the total of three phase current values is zero at this time, iw may not be input from the sensor and may be calculated from the values of iu and iv. Further, the rotation speed ωm of the electric motor 4 is obtained by the motor rotation sensor 5 constituted by a resolver or an encoder. The vehicle speed V (driven wheel speed V) is obtained from the vehicle speed sensor 11. The accelerator pedal opening θ is obtained by the accelerator pedal opening sensor 10. Further, the direct current voltage value Vdc [V] can be obtained from a power supply voltage value transmitted by a voltage sensor (not shown) provided in a direct current power supply line or a battery controller (not shown) provided in the battery 2.

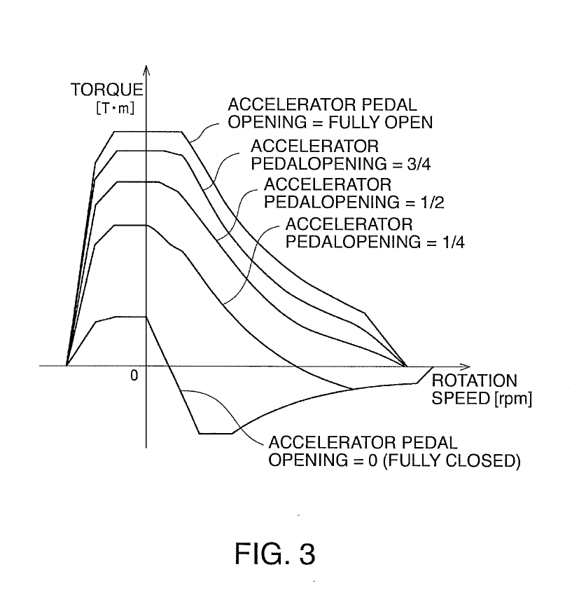

In a target torque calculation process of a step S2 following the step S1, a drive torque target value Tm is calculated based on the accelerator pedal opening θ and an electric motor rotation speed ωm using an accelerator pedal opening-torque table shown in FIG. 3.

Referring again to FIG. 2, in a road surface μ estimation process of a step S3 following the step S2, a friction coefficient μ of the road surface on which the vehicle is currently running is estimated based on the driven wheel speed V, a driven wheel acceleration dV/dt calculated from the driven wheel speed V, the electric motor rotation speed ωm and a vehicle equivalent mass M including a driven wheel inertia. The road surface μ estimation process of the step S3 will be described in detail later.

In a damping control constant changing process of a step S4, a natural vibration frequency fp of the vehicle is determined based on the road surface μ estimated in the step S3 described above and changes a control parameter of a damping control. Then, a first torque target value is calculated by performing a damping filter processing on the drive torque target value Tm calculated in the step S3 described above. A second torque target value Tm2 is calculated using an external disturbance suppression filter. A drive torque command value Tm* is then calculated by adding these torque target values. The damping control constant changing process of the step S4 will be described in detail later.

In a current command value calculation process of a step S5, dq-axis current target values id*, iq* are obtained by referring to a predetermined table based on the drive torque command value Tm* calculated in the step S4 described above, the electric motor rotation speed ωm and the direct current voltage value Vdc.

In a current control of a step S6, dq-axis current values id, iq are first computed from the three phase current values iu, iv and iw and the electric motor rotation speed ωm. Then, dq-axis voltage command values vd, vq are calculated from differences between the dq-axis current target values id*, iq* calculated in the step S5 described above and the computed dq-axis current values Id, iq. It should be noted that a noninterference control may be added in this part.

Subsequently, three-phase voltage command values vu, w, vw are computed from the dq-axis voltage command values vd, vq and the electric motor rotation speed ωm. PMW signals (on duty) to [%], tv [%] and tw [%] are computed from the computed three-phase voltage command values vu, w and vw and the direct current voltage Vdc. By ON/OFF controlling the switching elements of the inverter 3 by the thus obtained PWM signals, the electric motor 4 can be driven by a desired torque indicated by the drive torque command value Tm*.

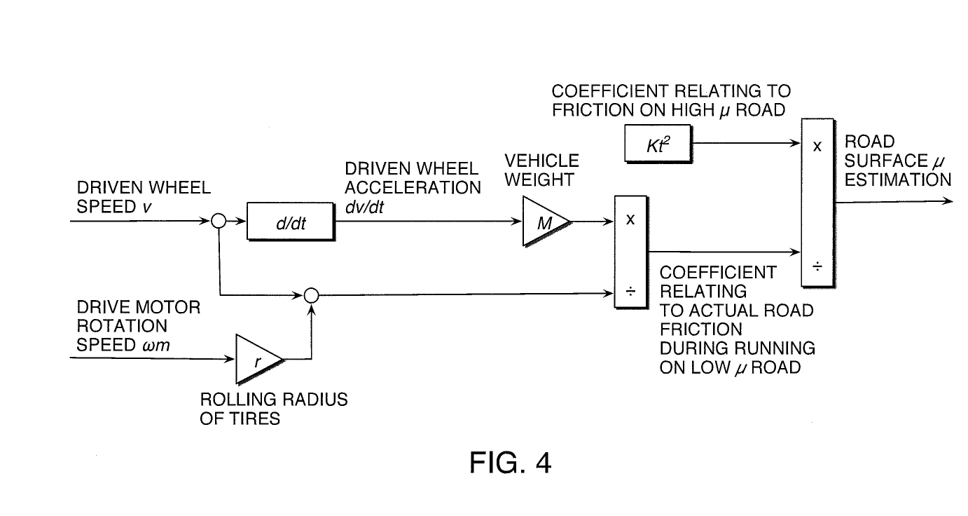

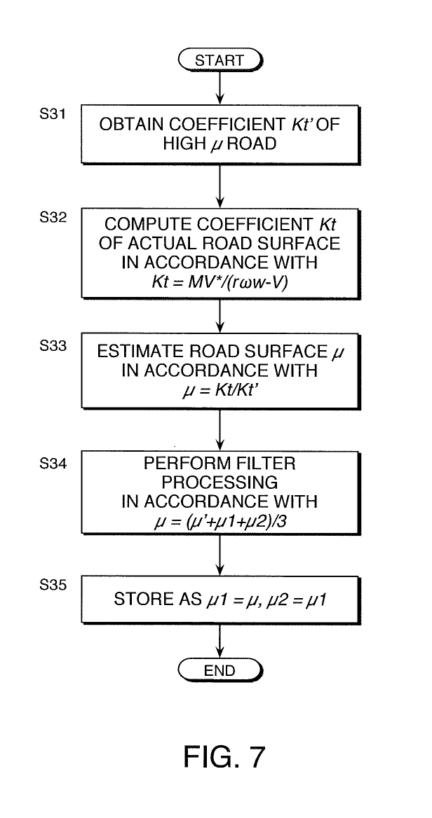

Next, the road surface μ estimation process of the step S3 of FIG. 2 will be described in detail based on a control block diagram shown in FIG. 4 and a flow chart shown in FIG. 7.

In the road surface μ estimation process according to this embodiment, a coefficient Kt on a low friction coefficient road surface (hereinafter, referred to as a “low μ road”) is first estimated from the driven wheel speed V, the driven wheel acceleration dV/dt and the motor rotation speed ωm. Using a coefficient Kt′ set in advance on a high friction coefficient road surface (hereinafter, referred to as a “high μ road”) and the coefficient Kt on a low friction coefficient road surface thus calculated, Kt/Kt′ is computed. The road surface μ is thereby estimated in real time. It should be noted that the coefficient Kt′ is a coefficient relating to friction between tires and the road surface during running on the high μ road and the coefficient Kt is a coefficient relating to actual road surface friction during running on the low μ road here.

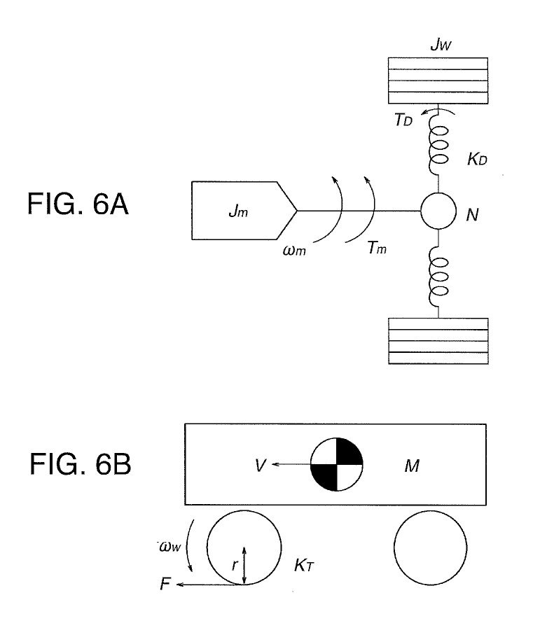

The road surface μ estimation process will now be described in detail. FIG. 6 is a diagram describing equations of motion of a drive torsional vibration system and each symbol in FIG. 6 is explained as follows.
Jm: inertia of electric motor
Jw: inertia of drive wheels
M: mass of vehicle
KD: torsional rigidity of drive system
Kt: coefficient relating to friction between tires and road surface
N: overall gear ratio
R: rolling radius of tires
ωm: angular velocity of electric motor
Tm*: drive torque command value
TD: torque of drive wheels
F: force applied to vehicle
V: vehicle speed
ωw: annular velocity of drive wheels

The following equations of motion can be derived from FIG. 6.

Jm·ωw*m=Tm−TD/N (1)

2Jw·ω*w=TD−rF (2)

MV*=F (3)

TD=KD∫(ωm/N−ωw)dt (4)

F=KT(rωw−V) (5)

Here, “*” attached to the upper right hand side of each symbol indicates temporal differentiation in the above equations (1) to (5).

In estimating the road surface μ, the coefficient Kt relating to the friction between the tires and the road surface computed in real time needs to be estimated. The following equation (6) can be derived from the above equations (3) and (5) and the following equation (7) can be obtained by transforming the equation (6).

MV*=Kt(rωw−V) (6)

Kt=MV*/(rωw−V) (7)

Thus, in this embodiment, the road surface μ on the low μ road is estimated by computing Kt/Kt′ based on the coefficient Kt computed in real time using the above equation (7) and the coefficient Kt′ calculated in advance and relating to the friction between the tires and the road surface during running on the high μ road.

Specifically, in this embodiment, the coefficient Kt relating to actual road surface friction (coefficient relating to friction during running on the low μ road) is calculated based on the electric motor rotation speed ωm, the rolling radius r of the tires, the vehicle speed V (driven wheel speed V) and the vehicle weight M in accordance with the above equation (7), and the road surface μ on the low μ road is estimated by computing Kt/Kt′ using the coefficient Kt and the coefficient Kt′ calculated in advance and relating to the friction between the tires and the road surface during running on the high μ road as shown in the control block diagram of FIG. 4.

A specific flow of such a road surface μ estimation process performed in accordance with the control block diagram shown in FIG. 4 is described based on the flow chart of FIG. 7.

First, in a step S31, the coefficient Kt′ relating to the friction between the tires and the road surface corresponding to the high μ road is obtained.

In a step S32, the coefficient Kt relating to the friction of the actual road surface is calculated based on the vehicle speed V (driven wheel speed V), the vehicle acceleration dV/dt (driven wheel acceleration dV/dt), the electric motor rotation speed ωm and the vehicle equivalent mass M including the driven wheel inertia in accordance with the above equation (7).

In a step S33, a road surface μ′ is calculated based on the coefficient Kt′ corresponding to the high μ road and the coefficient Kt of the actual road surface in accordance with the following equation (8).

μ′=Kt/Kt′ (8)

In a step S34, to calculate the road surface μ, the road surface μ′ calculated in the step S33 and the road surface μ calculated on the last occasion when the process was performed and the road surface μ calculated on the last but one occasion when the process was performed are read. The values calculated on the last occasion and on the last but one occasion are respectively read as a last value μ1 and a second last value μ2. The road surface μ is then calculated by performing a filter processing in accordance with the following equation (9). The calculated value is set as the road surface μ of the road surface on which the vehicle is currently running. It should be noted that the filter processing may use a low-pass filter or the like.

μ=(μ′+μ1+μ2)/3 (9)

Finally, in a step S35, the road surface μ obtained in the step S34 is stored as the last value μ1 (μ1←μ) to be used in the subsequent computation processings, and the last value pl read in the step S34 is stored as the second last value μ2 (μ2←μ1), whereby this process is finished.

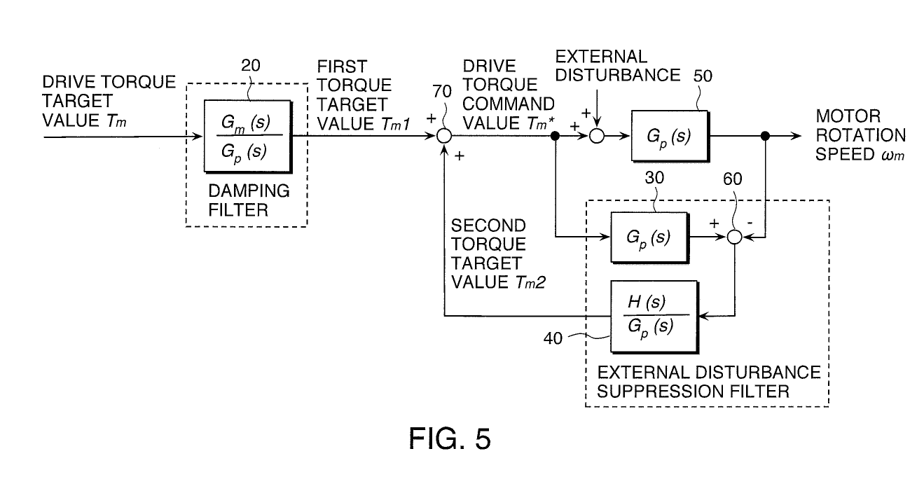

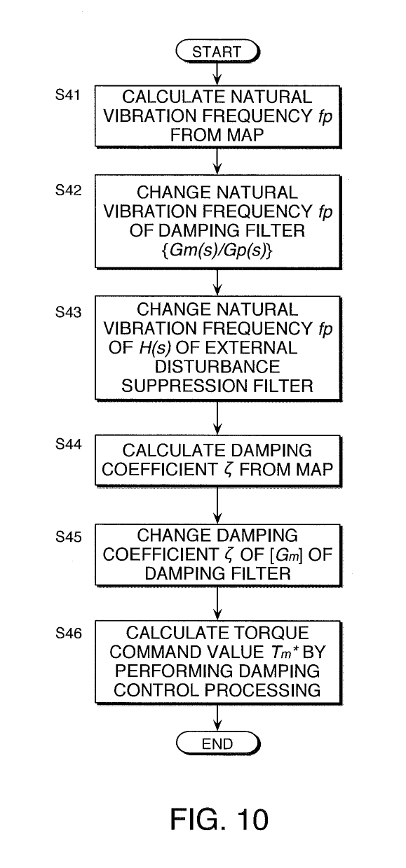

Next, the damping control constant changing process of the step S4 of FIG. 2 will be described in detail based on a control block diagram shown in FIG. 5 and a flow chart shown in FIG. 10.

First, the damping control in this embodiment will be described. In this embodiment, as shown in the control block diagram of FIG. 5, the first torque target value Tm1 is calculated by performing a damping filter processing on the drive torque target value Tm, the second torque target value Tm2 is calculated using an external disturbance suppression filter, and a drive torque command value Tm* is calculated by adding these torque target values. Rotational vibration based on resonance with a wheel drive system from the electric motor to the wheels is suppressed by using the thus calculated drive torque command value Tm*.

As shown in FIG. 5, control blocks according to this embodiment include a control block 20 having a transfer characteristic Gm(s)/Gp(s), and the control block 20 calculates the first torque target value by performing the filter processing on the drive torque target value Tm, which was calculated based on the accelerator pedal opening B and the electric motor rotation speed com using the accelerator pedal opening-torque table shown in FIG. 3, using a control filter having the transfer characteristic Gm(s)/Gp(s). Herein, Gp(s) is a model indicating a transfer characteristic of a torque input to the vehicle and the motor rotation speed, and Gm(s) is a model (ideal model) indicating response targets of the torque input to the vehicle and the motor rotation speed.

Further, the control blocks according to this embodiment include a control block 30 having the above transfer characteristic Gp(s), a control block 40 including a subtractor 60 for computing a deviation between an output value of the control block 30 and the motor rotation speed com, having a transfer characteristic H(s)/Gp(s) and configured for filter output using the deviation computed by the subtractor 60 as an input, and an adder 70 for adding an output of the control block 40 and the first torque target value Tm1. It should be noted that the above transfer characteristic H(s) is so set that a difference between a denominator degree and a numerator degree of the transfer characteristic H(s) is not smaller than a difference between a denominator degree and a numerator degree of the transfer characteristic Gp(s).

Here, the transfer characteristic Gp(s) from the electric motor toque to the electric motor rotation speed is obtained as expressed in the following equations (10) to (18) from the equations of motion expressed in the above equations (1) to (5) calculated in the drive torsional vibration system shown in FIG. 6 as described above.

Gp(s)=(b₃s³+b₂s²+b₁s+b₀/s(a₄s³+a₃s²+a₂s+a₁) (10)

a₄=2Jm·Jw·M (11)

a₃=Jm(2Jw+Mr²)KT (12)

a₂=(Jm+2Jw/N²)M·KD (13)

a₁=(Jm+2Jw/N²+Mr²/N²)KD·KT (14)

b₃=2Jw−M (15)

b₂=(2Jw+Mr²)KT (16)

b₁=M·KD (17)

b₀=KD·KT (18)

If a pole and a zero of a transfer function expressed in the above equation (10) are checked, one pole and one zero indicate values very close to each other. This is equivalent to that α, β of the following equation (19) indicate values very close to each other.

Gp(s)=(s+β)(b₂′s²+b₁′s+b₀′)/s(s+α)(a₃′s²+a₂′s+a₁′) (19)

Accordingly, (second-order)/(third-order) transfer characteristic Gp(s) as shown in the following equation (20) is formed through a pole-zero offset (similar to α=β) in the above equation (19).

Gp(s)=(b₂′s²+b₁′s+b₀′)/s(a₃′s²+a₂′s+a₁′) (20)

Since the above equation (20) is realized by a microcomputer processing in this embodiment, Z-transform is performed for discretization using the following equation (21).

s=(2/T)·{(1−Z⁻¹)(1+Z⁻¹)} (21)

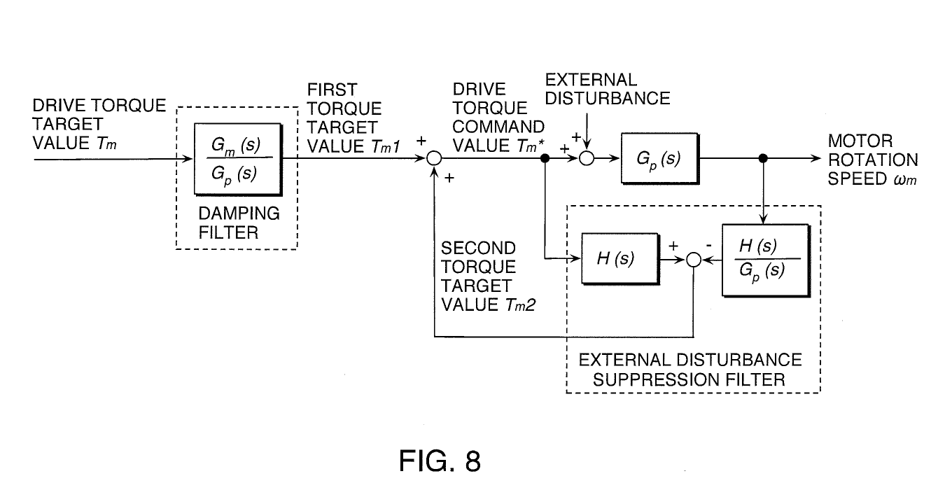

Herein, since the transfer characteristic Gp(s) expressed in the above equation (21) has a pure integral term, the control blocks shown in FIG. 5 can be equivalently converted into control blocks shown in FIG. 8, specifically can be converted into a configuration including a control block having the transfer characteristic H(s) and a control block having the transfer characteristic H(s)/Gp(s), whereby the occurrence of a drift can be prevented.

Further, if the transfer characteristic Gp(s) is so configured that each constant is changed according to a speed ratio when the speed ratio of the vehicle is variable, a highly accurate damping effect can be constantly obtained regardless of the speed ratio.

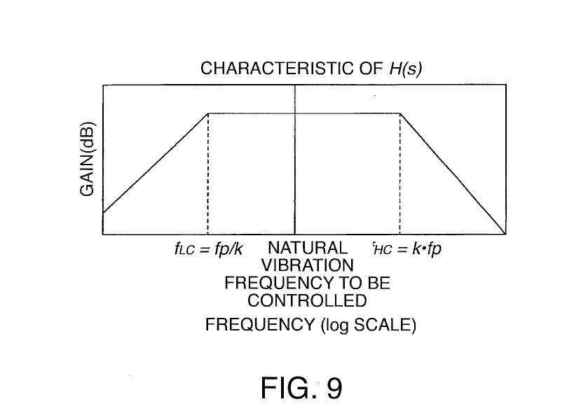

Next, the transfer characteristic H(s) of the external disturbance suppression filter shown in FIG. 5 will be described. The transfer characteristic H(s) serves as a feedback element for reducing only vibration in the case of being used as a band pass filter. At this time, if a characteristic of the band pass filter is set as shown in FIG. 9, a largest effect can be obtained. Specifically, the transfer characteristic H(s) is so set that damping characteristics on a low pass side and on a high pass side substantially match and a torsional resonance frequency of the drive system is near a central part of a pass band on a logarithmic axis (log scale). For example, if the transfer characteristic H(s) is a first-order high pass filter, it is configured as in the following equation (22) using the frequency fp as the torsional resonance frequency of the drive system and k as an arbitrary value.

H(s)=τHs/{(1+τHs)·(1+τLs)} (22)

where, τTL=1/(2πfHC),
fHC=kfp,
τH=1/(2πfLC) and
fLC=fp/k.

The above constant “k” is limited in magnitude to maintain the stability of the control system, but provides a larger effect with an increase in magnitude. Further, depending on cases, it is possible to select a value not greater than unity. This can be used by being Z-transformed and discretized as in the aforementioned case.

Next, the damping control constant changing process will be described.

First, a natural vibration angular velocity ωₚ is as expressed in the following equation (23) using coefficients a₁′, a₃′ of the denominator of the above equation (20) expressing the model Gp(s) of the drive torque input of the vehicle and the electric motor rotation speed.

ωₚ=(a₁′/a₃′)^{1/2} (23)

The natural vibration angular velocity ωₚ can be converted into the natural vibration frequency fp by the following equation (24).

fp =ωₚ/2π (24)

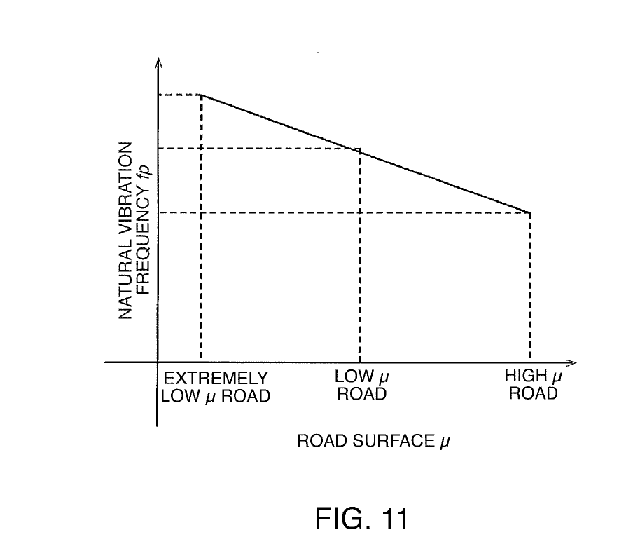

In this embodiment, the natural vibration frequency fp by the road surface μ is calculated according to the road surface μ calculated according to the aforementioned method (see the step S34 of FIG. 7) using a map shown in FIG. 11, and the control parameter constituting the damping filter Gm(s)/Gp(s), specifically the control parameter of Gp(s) is adjusted using the natural vibration frequency fp. Specifically, to remove or reduce a frequency component formed from the calculated natural vibration frequency fp from a vehicle drive system, the first torque target value is calculated by performing the filter processing on the drive torque target value Tm using the damping filter Gm(s)/Gp(s) whose control parameter is adjusted by the natural vibration frequency fp. It should be noted that, in this embodiment, a higher natural vibration frequency fp is set as the calculated road surface μ decreases and, conversely, a lower natural vibration frequency fp is set as the calculated road surface μ increases as shown in FIG. 11.

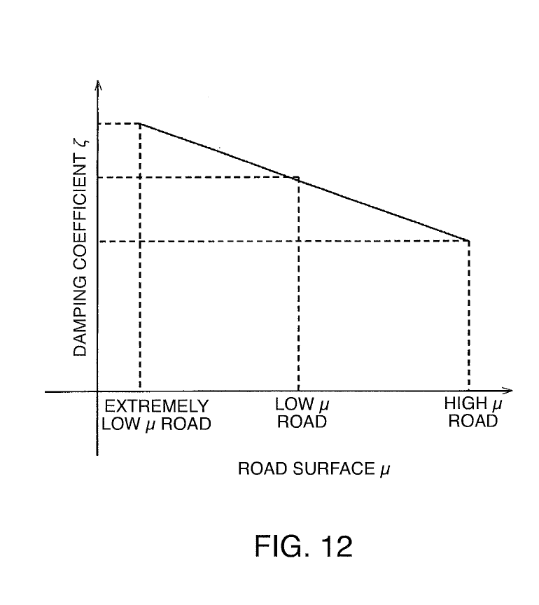

Further, in this embodiment, the damping coefficient ζby the road surface μ is calculated according to the road surface μ calculated according to the aforementioned method (see the step S34 of FIG. 7) using a map shown in FIG. 12, and the control parameter constituting the damping filter Gm(s)/Gp(s), specifically the control parameter of Gm(s) is adjusted using the damping coefficient ζ. Particularly, according to this embodiment, the occurrence of a modeling error can be effectively suppressed even if the road surface μ becomes low by adopting such a configuration. It should be noted that, in this embodiment, a higher damping coefficient ζ is set as the calculated road surface μ decreases and, conversely, a lower damping coefficient ζ is set as the calculated road surface μ increases as shown in FIG. 12. Further, since the damping coefficient ζ is desirably a value greater than unity and a damping width near the natural vibration frequency can be, thereby, widened, an effect of suppressing vibration in response to torsional vibration of the vehicle drive system can be obtained even if there is a modeling error.

In addition, in this embodiment, the natural vibration frequency fp is calculated according to the road surface μ calculated according to the aforementioned method (see the step S34 of FIG. 7) using the map shown in FIG. 11. The control parameters constituting the external disturbance suppression filter H(s)/Gp(s), specifically the control parameters of H(s) and Gp(s) are adjusted using the natural vibration frequency fp. Particularly, according to this embodiment, by adopting such a configuration, the effect of suppressing vibration in response to torsional vibration of the vehicle drive system can be further improved even if the road surface μ becomes low.

Next, a specific flow of such a damping control constant changing process performed in accordance with the control block diagram shown in FIG. 5 is described with reference to the flow chart shown in FIG. 10.

First, in a step S41, the natural vibration frequency fp corresponding to the road surface μ is calculated based on the road surface μ calculated in the step S34 of FIG. 7 referring to the map shown in FIG. 11.

In a step S42, the control parameter constituting Gp(s) of the damping filter Gm(s)/Gp(s) is adjusted using the natural vibration frequency fp calculated in the step S41 described above.

In a step S43, the control parameters of H(s) and Gp(s) of the external disturbance suppression filter H(s)/Gp(s) is adjusted using the natural vibration frequency fp calculated in the step S41 described above.

In a step S44, the damping coefficient ζ of Gm(s) corresponding to the road surface μ is calculated based on the road surface μ calculated in the step S34 of FIG. 7 using the map shown in FIG. 12.

In a step S45, the control parameter constituting Gm(s) of the damping filter Gm(s)/Gp(s) is adjusted using the damping coefficient calculated in the step S44.

Finally, in a step S46, as shown in FIG. 5, the first torque target value is calculated by performing the damping filter processing on the drive torque target value Tm calculated in the step S2 using each control parameter calculated in the steps S41 to S45 described above, the second torque target value Tm2 is calculated by performing the external disturbance filter processing based on the drive torque command value Tm* and an actual measurement value of the motor rotation speed, the drive torque command value Tm* is obtained by adding these and this process is finished.

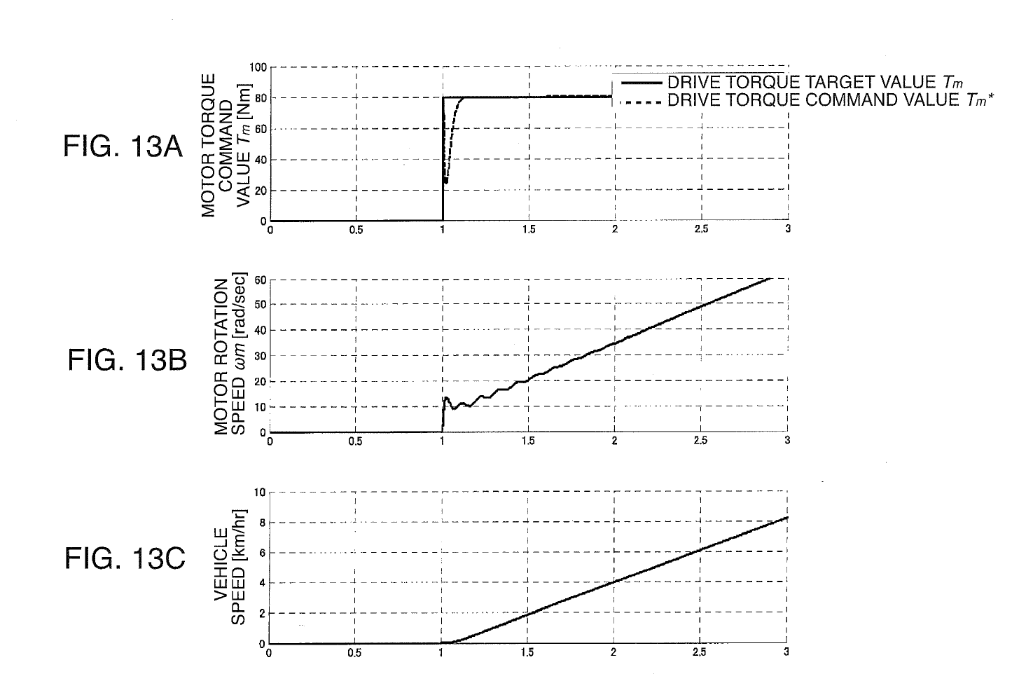

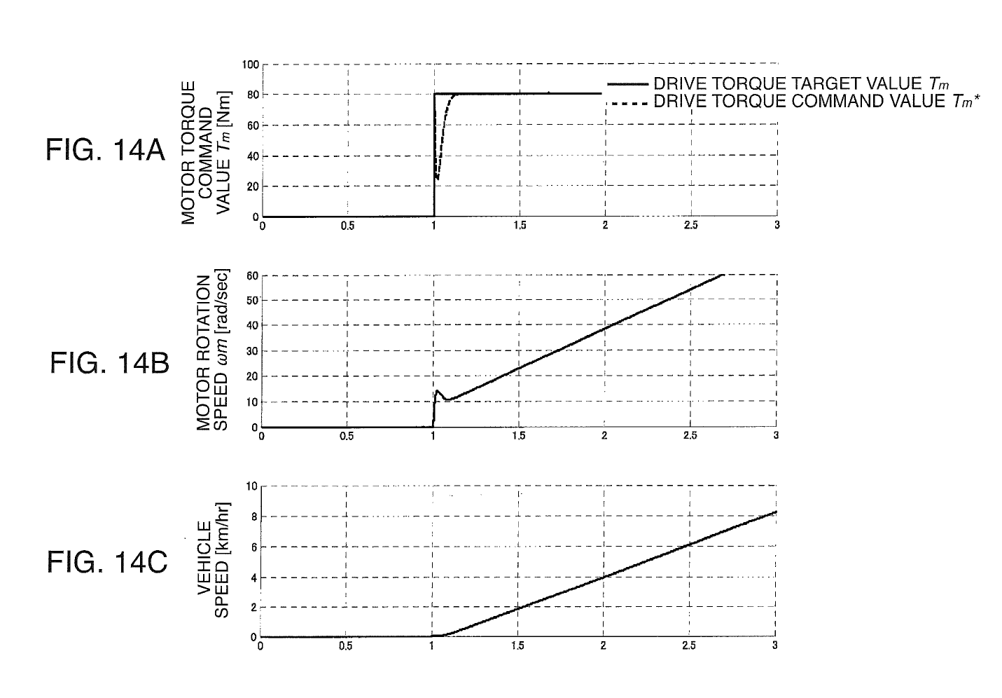

Next, the control of this embodiment and a conventional control are compared. FIG. 13 is a time chart showing a conventional control and FIG. 14 is a time chart showing the control result according to this embodiment. In examples shown in FIGS. 13 and 14, a case is illustrated where the drive torque target value Tm is input stepwise on a low μ road at time 1 sec to accelerate. It should be noted that, in a time period from time 0 sec to time 1 sec, motor command torque is 0 [Nm] and a vehicle is stationary.

First, a result in the case of acceleration by calculating the drive torque command value Tm* using the damping filter and the external disturbance suppression filter corresponding to a high μ road for the drive torque target value Tm is shown in the conventional example shown in FIG. 13. As shown in FIG. 13, in the conventional example, the damping control parameter is not optimal at the start of acceleration at time 1 sec, which results in hunting in the motor rotation speed from time 1 sec to time 2 sec.

In contrast, a result in the case of acceleration by calculating the drive torque command value Tm* by performing the filter processing on the drive torque target value Tm using the damping filter and the external disturbance suppression filter corresponding to the road surface μ is shown as an example according to this embodiment in FIG. 14. As shown in FIG. 14, according to this embodiment, the damping control parameter is appropriate at the start of acceleration at time 1 sec. As a result, the effect of suppressing vibration in response to torsional vibration of the vehicle drive system is reliably obtained and smooth acceleration is realized also on a low μ road.

As described above, according to the embodiment of this invention, the control parameter used in the damping control in executing the damping control for reducing torsional vibration of the vehicle drive system is adjusted according to the road surface μ. Thus, a resonance point of the electric motor 4 and the wheel drive system from the electric motor 4 to the wheels can be reliably estimated even when the road surface μ changes. By reflecting this resonance point on the damping control, torsional vibration of the vehicle drive system when the road surface μ changes can be effectively suppressed. According to this embodiment, therefore, a reliable damping effect is obtained even when the accelerator pedal is depressed in a stopped state or a decelerated state on a low μ road, thereby reducing hunting in the rotation speed and realizing smooth acceleration.

Further, according to this embodiment, the filter processing is performed by the damping filter Gm(s)/Gp(s) on the drive torque target value Tm to change the control parameter of the damping filter Gm(s)/Gp(s) when the road surface μ changes. Accordingly, the effect of suppressing torsional vibration of the vehicle drive system can be precisely obtained also on a low μ road.

Still further, according to this embodiment, H(s) constituting the external disturbance suppression filter H(s)/Gp(s) has the band pass filter characteristic whose center frequency matches the torsional natural vibration frequency of the drive system of the vehicle corresponding to the road surface μ (see FIG. 9). As a result, a canceling torque is given at a zero phase difference to theoretically unnecessary vibration by configuring the drive system such that the torsional natural vibration frequency thereof is in a center of the normal band of H(s) on a logarithmic axis. This is effective in suppressing vibration. Therefore, according to this embodiment, the effect of suppressing vibration in response to torsional vibration of the vehicle drive system can be precisely obtained even on a low μ road by changing H(s) constituting the external disturbance suppression filter H(s)/Gp(s) when the road surface μ changes.

Still further, according to this embodiment, Gm(s) of the damping filter Gm(s)/Gp(s) calculates a normative response using the drive torque target value Tm as an input. By changing the control parameter of Gm(s) when the road surface μ changes, importance can be attached to the stability of the transfer characteristic of the Gm(s) as a normative response, whereby the effect of suppressing vibration in response to torsional vibration of the vehicle drive system can be precisely obtained even when there is a modeling error. Although the damping filter tends to have a modeling error as the road surface μ decreases, this may be prevented by the above process.

Still further, according to this embodiment, the road surface μ is estimated based on the driven wheel speed, the acceleration, the drive wheel speed computed from the motor rotation speed and the vehicle equivalent weight including the driven wheel inertia. Thus, the road surface μ can be estimated in real time during vehicle running. The road surface μ can be estimated more accurately than that obtained by a method of calculating a slip ratio from a deviation between the drive wheel speed and the driven wheel speed and changing parameters according to the slip ratio.

It should be noted that, in the embodiment described above, the electric motor controller 1 corresponds to each of a damping control means, a friction coefficient estimation means, a control parameter correction means, a drive torque target value setting means and a motor rotation speed estimation means of this invention.

Although the invention has been described above with reference to a certain embodiment, the invention is not limited to the embodiment described above. Modifications and variations of the embodiment described above will occur to those skilled in the art, within the scope of the claims.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

### List of Reference Signs

1: electric motor controller

2: battery

3: inverter

4: electric motor

5: motor rotation sensor

6: current sensor

7: transmission

8: reduction gear

9: drive wheel

10: accelerator pedal opening sensor

11: vehicle speed sensor

12: wheel speed sensor

1-10. (canceled)

11. A damping control device of a vehicle using an electric motor for suppressing vibration of the vehicle using the electric motor as a power source, comprising:
a programmable controller programmed to:
set a drive torque target value based on vehicle information of the vehicle;
perform filter processing on the drive torque target value using a damping filter having a characteristic of removing or reducing a frequency component equivalent to torsional vibration of a vehicle drive system based on a vehicle information of the vehicle and an external disturbance suppression filter for suppressing external disturbance, the damping filter calculating a first torque target value and having a characteristic Gm(s)/Gp(s) configured by a model Gp(s) of a transfer characteristic of a torque input to the vehicle and a motor rotation speed and an ideal model Gm(s) of the transfer characteristic of the torque input and the motor rotation speed set in advance;
reduce the torsional vibration of the vehicle drive system by causing the electric motor to drive using a motor torque command value calculated based on the first torque target value;
estimate a friction coefficient of a road surface on which the vehicle is running;
calculate a natural vibration frequency, which is a resonance frequency of an electric motor and a wheel drive system based on the friction coefficient of the road surface; and
correct a control parameter of the model Gp(s) using the calculated natural vibration frequency such that the value of the natural vibration frequency in the control parameter of Gp(s) increases with a decrease in the friction coefficient of the road surface.

12. A damping control device of a vehicle using an electric motor for suppressing vibration of the vehicle using the electric motor as a power source, comprising:
a programmable controller programmed to:
set a drive torque target value based on vehicle information of the vehicle;
perform filter processing on the drive torque target value using a damping filter having a characteristic of removing or reducing a frequency component equivalent to torsional vibration of a vehicle drive system based on a vehicle information of the vehicle and an external disturbance suppression filter for suppressing external disturbance, the damping filter calculating a first torque target value and having a characteristic Gm(s)/Gp(s) configured by a model Gp(s) of a transfer characteristic of a torque input to the vehicle and a motor rotation speed and an ideal model Gm(s) of the transfer characteristic of the torque input and the motor rotation speed set in advance;
reduce the torsional vibration of the vehicle drive system by causing the electric motor to drive using a motor torque command value calculated based on the first torque target value;
estimate a friction coefficient of a road surface on which the vehicle is running;
calculate a natural vibration frequency, which is a resonance frequency of an electric motor and a wheel drive system, corresponding to the friction coefficient based on the friction coefficient of the road surface;
correct a control parameter of Gp(s) constituting the damping filter using the calculated natural vibration frequency;
calculate a rotation speed estimated value of the electric motor by inputting the motor torque command value;
calculate a second torque target value by processing a difference between the rotation speed estimated value of the electric motor and an actual rotation speed of the electric motor using the external disturbance suppression filter having a characteristic H(s)/Gp(s) configured by the model Gp(s) and a transfer function H(s) whose difference between a denominator degree and a numerator degree is not smaller than a difference between a denominator degree and a numerator degree of the model Gp(s);
cause the electric motor to drive using a motor torque command value calculated based on the first and second torque target values; and
correct the control parameter of Gp(s) such that the value of the natural vibration frequency in control parameters of H(s), Gp(s) increases with a decrease in the friction coefficient of the road surface.

13. A damping control device of a vehicle using an electric motor for suppressing vibration of the vehicle using the electric motor as a power source, comprising:
programmable controller programmed to:
estimate a friction coefficient of a road surface on which the vehicle is running;
perform filter processing on the drive torque target value using a damping filter having a characteristic of removing or reducing a frequency component equivalent to torsional vibration of a vehicle drive system based on vehicle information of the vehicle and an external disturbance suppression filter for suppressing external disturbance, the damping filter calculating a first torque target value by performing a filter processing on the drive torque target value and having a characteristic Gm(s)/Gp(s) configured by a model Gp(s) of a transfer characteristic of a torque input to the vehicle and a motor rotation speed and an ideal model Gm(s) of the transfer characteristic of the torque input and the motor rotation speed set in advance;
reduce the torsional vibration of the vehicle drive system by causing the electric motor to drive using a motor torque command value calculated based on the first torque target value;
estimate a friction coefficient of a road surface on which the vehicle is running;
correct a control parameter in executing a damping control based on the friction coefficient of the road surface;
set the drive torque target value based on the vehicle information of the vehicle; and
correct the control parameter in executing the damping control such that a damping width of a damping coefficient indicating a damping characteristic, in control parameter of the model Gm(s) increases with a decrease in the friction coefficient of the road surface.

14. The damping control device according to claim 1, wherein the controller is further programmed to estimate the friction coefficient of the road surface based on a driven wheel speed, an acceleration, a drive wheel speed computed from the motor rotation speed and a vehicle equivalent weight including a driven wheel inertia.

15. A damping control device of a vehicle using an electric motor for suppressing vibration of the vehicle using the electric motor as a power source, comprising:
a drive torque target value setting means configured to set a drive torque target value based on vehicle information of the vehicle;
a damping control means including a damping filter having a characteristic of removing or reducing a frequency component equivalent to torsional vibration of a vehicle drive system based on the vehicle information of the vehicle and an external disturbance suppression filter for suppressing external disturbance and configured to calculate a first torque target value by performing a filter processing on the drive torque target value using the damping filter having a characteristic Gm(s)/Gp(s) configured by a model Gp(s) of a transfer characteristic of a torque input to the vehicle and a motor rotation speed and an ideal model Gm(s) of the transfer characteristic of the torque input and the motor rotation speed set in advance, and reduce the torsional vibration of the vehicle drive system by causing the electric motor to drive using a motor torque command value calculated based on the first torque target value; and
a friction coefficient estimation means configured to estimate a friction coefficient of a road surface on which the vehicle is running; and
a control parameter correction means configured to calculate a natural vibration frequency, which is a resonance frequency of an electric motor and a wheel drive system, corresponding to the friction coefficient based on the friction coefficient of the road surface estimated by the friction coefficient estimation means, and correct a control parameter of Gp(s) constituting the damping filter using the calculated natural vibration frequency;
wherein the control parameter correction means makes such a correction that the value of the natural vibration frequency in the control parameter of Gp(s) constituting the damping filter increases with a decrease in the friction coefficient of the road surface estimated by the friction coefficient estimation means.

16. A damping control method of a vehicle using an electric motor for suppressing vibration of the vehicle using the electric motor as a power source, comprising:
setting a drive torque target value based on vehicle information of the vehicle;
performing filter processing on the drive torque target value using a damping filter having a characteristic of removing or reducing a frequency component equivalent to torsional vibration of a vehicle drive system based on a vehicle information of the vehicle and an external disturbance suppression filter for suppressing external disturbance, the damping filter calculating a first torque target value and having a characteristic Gm(s)/Gp(s) configured by a model Gp(s) of a transfer characteristic of a torque input to the vehicle and a motor rotation speed and an ideal model Gm(s) of the transfer characteristic of the torque input and the motor rotation speed set in advance;
reducing the torsional vibration of the vehicle drive system by causing the electric motor to drive using a motor torque command value calculated based on the first torque target value;
estimating a friction coefficient of a road surface on which the vehicle is running;
calculating a natural vibration frequency, which is a resonance frequency of an electric motor and a wheel drive system based on the friction coefficient of the road surface; and
correcting a control parameter of the model Gp(s) using the calculated natural vibration frequency such that the value of the natural vibration frequency in the control parameter of Gp(s) increases with a decrease in the friction coefficient of the road surface.
